(19) United States
(12) Patent Application Publication
(10) Pub. No.: US 2014/0110225 A1
(43) Pub. Date: Apr. 24, 2014

(54) CONVEYOR ASSEMBLY WITH GEARED, REMOVABLE ROLLERS FOR A VAPOR DEPOSITION SYSTEM

(71) Applicant: PRIMESTAR SOLAR, INC., Arvada, CO (US)

(72) Inventor: Christopher Rathweg, Louisville, CO (US)

(73) Assignee: PRIMESTAR SOLAR, INC., Arvada, CO (US)

(21) Appl. No.: 13/658,920

(22) Filed: Oct. 24, 2012

(51) Int. Cl. B65G 13/07

(52) U.S. Cl. 198/790

(57) ABSTRACT

A conveyor assembly for conveying substrates through a vapor deposition system is disclosed. The conveyor assembly may generally include a first carriage rail disposed on a drive side of the conveyor assembly and a second carriage rail disposed on an opposite side of the conveyor assembly. Each of the carriage rails may define a plurality of roller positions, with a plurality of the roller positions on the first carriage rail being configured as drive positions. The conveyor assembly may also include a drive pulley positioned at each drive position. Each drive pulley may be configured to rotationally drive a drive device. In addition, the conveyor assembly may include a plurality of rollers extending between the carriage rails at the roller positions. The rollers disposed at the drive positions may be configured to engage the drive devices.

### FIELD OF THE INVENTION

The present subject matter relates generally to the field of thin film vapor deposition systems, wherein a thin film layer, such as a semiconductor layer, is deposited on a substrate conveyed through the system. More particularly, the present subject matter is related to a geared conveyor system used to move the substrates through a vapor deposition system.

### BACKGROUND OF THE INVENTION

Production of thin film photovoltaic (PV) modules (also referred to as “solar panels”) typically involves conveyance of a substrate, such as a glass panel, into and out of a vapor deposition chamber wherein a thin film layer (generally recognized in the industry as less than 10 μm) of a semiconductor material, such as cadmium telluride (CdTe) is deposited onto the surface of the substrate. The deposition process may be any known process, such as a close space sublimation (CSS) system, a chemical vapor deposition (CVD) system, or physical vapor deposition (PVD) system.

Solar energy systems using CdTe PV modules are generally recognized as the most cost efficient of the commercially available systems in terms of cost per watt of power generated. However, the advantages of CdTe not withstanding, sustainable commercial exploitation and acceptance of solar power as a supplemental or primary source of industrial or residential power depends on the ability to produce efficient PV modules on a large scale and in a cost effective manner. In this regard, it is highly desirable to reduce down-time of the vapor deposition system used in production of the PV modules.

Typically, various types of conveyors are utilized to move the PV module substrates through the vapor deposition system. Components of the conveyors may be exposed to the source material vapors, which can condense into a detrimental buildup of the source material on the conveyor components. In this situation, the conveyor components need to be removed and cleaned or replaced with clean components. The conveyor components may also need to be removed for periodic maintenance, replacement, or other procedures requiring shutdown of the system. Reduction of system downtime associated with conveyor maintenance, replacement, or other reasons is an ongoing concern.

U.S. Patent Publication No. 2011/0155063 (Little et. al), filed on Dec. 30, 2011 and entitled “Conveyor Assembly with Removable Rollers for a Vapor Deposition System,” the disclosure of which is hereby incorporated by reference herein for all purposes, describes a conveyor assembly that includes removable rollers, thereby allowing for a reduction in the downtime associated with component replacement and maintenance. However, while this conveyor assembly provides significant advantages over other prior art conveyors, it is still believed that the overall operation of the conveyor assembly can be improved.

Accordingly, there still exists a need for an improved conveyor assembly particularly suited for conveyance of substrates conveyed through a vapor deposition that reduces downtime associated with component replacement and maintenance. The present subject matter relates to a conveyor assembly that serves this purpose.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a conveyor assembly for conveying substrates through a vapor deposition system. The conveyor assembly may generally include a first carriage rail disposed on a drive side of the conveyor assembly and a second carriage rail disposed on an opposite side of the conveyor assembly. Each of the carriage rails may define a plurality of roller positions, with a plurality of the roller positions on the first carriage rail being configured as drive positions. The conveyor assembly may also include a drive pulley positioned at each drive position. Each drive pulley may be configured to rotationally drive a drive device. In addition, the conveyor assembly may include a plurality of rollers extending between the carriage rails at the roller positions. The rollers disposed at the drive positions may be configured to engage the drive devices.

In another aspect, the present subject matter is directed to a vapor deposition module for use in conveying a substrate through a vapor deposition system wherein a source material is converted to a vapor and deposited onto a surface of the substrate. The vapor deposition module may include a housing and a conveyor assembly operably configured within the housing to convey a substrate through the housing. The conveyor assembly may generally include a first carriage rail disposed on a drive side of the conveyor assembly and a second carriage rail disposed on an opposite side of the conveyor assembly. Each of the carriage rails may define a plurality of roller positions, with a plurality of the roller positions on the first carriage rail being configured as drive positions. The conveyor assembly may also include a drive pulley positioned at each drive position. Each drive pulley may be configured to rotationally drive a drive device. In addition, the conveyor assembly may include a plurality of rollers extending between the carriage rails at the roller positions. The rollers disposed at the drive positions may be configured to engage the drive devices.

In a further aspect, the present subject matter is directed to a vapor deposition system configured for converting to vapor and depositing a source material onto a surface of a substrate conveyed through the system. The vapor deposition system may include a plurality of individual, longitudinally aligned modules. The modules may define a conveyance path for the substrates conveyed through the system and each module may include a housing and a conveyor assembly operably configured within the housing to convey the substrates through the housing. The conveyor assembly may generally include a first carriage rail disposed on a drive side of the conveyor assembly and a second carriage rail disposed on an opposite side of the conveyor assembly. Each of the carriage rails may define a plurality of roller positions, with a plurality of the roller positions on the first carriage rail being configured as drive positions. The conveyor assembly may also include a drive pulley positioned at each drive position. Each drive pulley may be configured to rotationally drive a drive device. In addition, the conveyor assembly may include a plurality of rollers extending between the carriage rails at the roller positions. The rollers disposed at the drive positions may be configured to engage the drive devices.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWING

A full and enabling disclosure of the present invention, including the best mode thereof, is set forth in the specification, which makes reference to the appended drawings, in which:

FIG. 1 illustrates a side view of one embodiment of a vapor deposition system including modules having conveyor assemblies in accordance with aspects of the present subject matter;

FIG. 2 illustrates a simplified, top view of vapor deposition modules including embodiments of conveyor assemblies in accordance with aspects of the present subject matter;

FIG. 3 illustrates a simplified side, cut-away view of one of the vapor deposition modules shown in FIG. 2;

FIG. 4 illustrates a perspective view of one embodiment of a conveyor assembly in accordance with aspects of the present subject matter;

FIG. 5 illustrates an enlarged, perspective view of a portion of the conveyor assembly shown in FIG. 4;

FIG. 6 illustrates a top view of a portion of the conveyor assembly shown in FIG. 5, particularly illustrating the geared arrangement of one of the rollers of the conveyor assembly;

FIG. 7 illustrates a cross-sectional view of the portion of conveyor assembly shown in FIG. 6 taken about line 7-7; and,

FIG. 8 illustrates a cross-sectional view of the portion of conveyor assembly shown in FIG. 6 taken about line 8-8.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention encompass such modifications and variations as come within the scope of the appended claims and their equivalents.

In general, the present subject matter is directed to a conveyor assembly used to move substrates through a vapor deposition system. In particular, the present subject matter disclosed a conveyor assembly including geared, removable rollers. Thus, unlike the conveyor assembly disclosed in U.S. Patent Publication No. 2011/0155063 (described above) that includes friction-driven, removable rollers, the rollers of the disclosed conveyor assembly are driven via meshing gears. Such a direct-drive configuration may allow for an exact, constant relationship to be established between the rotational speed of the drive unit driving the conveyor assembly and the actual or final rotational speed of the rollers, thereby providing for precise control of the speed through which substrates may be conveyed through the vapor deposition system. Accurate speed control of the rollers may greatly enhance the overall operation of the vapor deposition system, such as by ensuring a constant thickness of the source material deposited onto the substrates. Moreover, friction-driven rollers may often get struck, which can lead to scratching of the substrate as it moves over the stuck roller(s). However, the configuration described herein provides for continuous rotation of the rollers, thereby preventing scratching of the substrate.

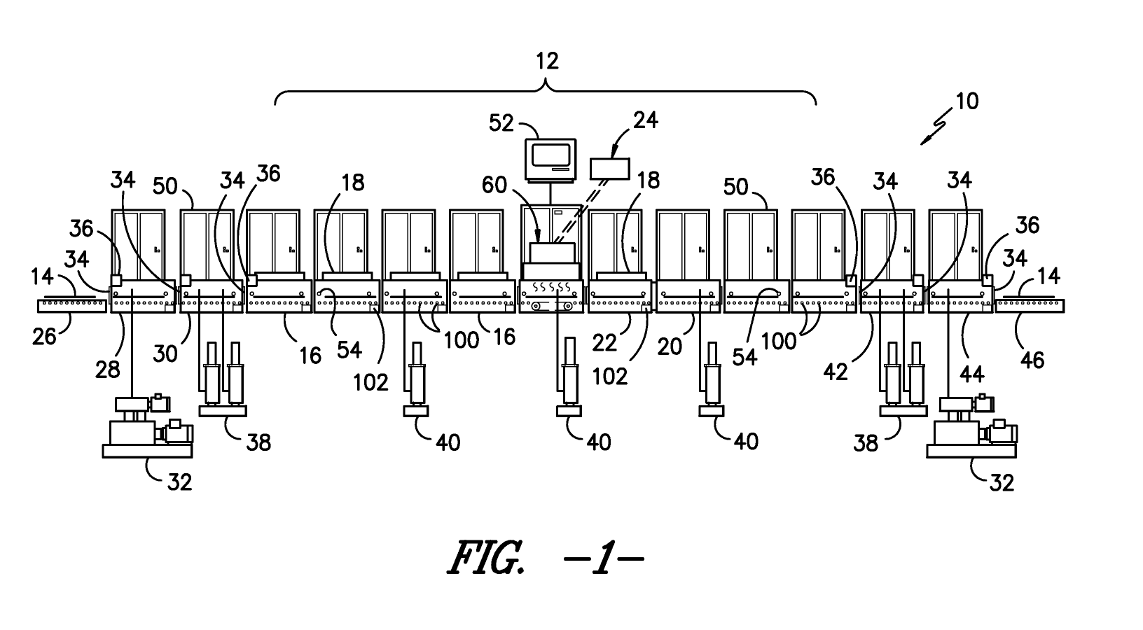

Referring now to the drawings, FIG. 1 illustrates one embodiment of a vapor deposition system 10 that may incorporate various embodiments of a conveyor assembly 100 in accordance with aspects of the present subject matter, particularly as components of various types of modules that make up the system 10. For reference and an understanding of an environment in which the present conveyor assemblies 100 may be used, the system 10 of FIG. 1 is described below, followed by a detailed description of particular embodiments of the conveyor assemblies 100.

The system 10 is generally configured for deposition of a thin film layer on a photovoltaic (PV) module substrate 14 (referred to hereafter as simply “substrate 14”). The thin film may be, for example, a film layer of cadmium telluride (CdTe). As indicated above, it is generally recognized in the art that a “thin” film layer on a PV module substrate is generally less than about 10 microns (μm). It should be appreciated that the conveyor assemblies 100 are not limited to use in the system 10 illustrated in FIG. 1, but may be incorporated into any suitable processing line configured for vapor deposition of a thin film layer onto a substrate 14.

As shown in FIG. 1, the exemplary system 10 includes a vacuum chamber 12 defined by a plurality of interconnected modules. Any combination of vacuum pumps 40 may be configured with the interconnected modules to draw and maintain a vacuum effective for the deposition process within the chamber 12. A plurality of interconnected heater modules 16 define a pre-heat section of the vacuum chamber 12 through which the substrates 14 are conveyed and heated to a desired temperature before being conveyed into a vapor deposition apparatus 60. Each of the heater modules 16 may include a plurality of independently controlled heaters 18, with the heaters 18 defining a plurality of different heat zones. A particular heat zone may include more than one heater 18. The heaters 18 may be disposed above or below the module bodies.

The vapor deposition apparatus 60 may take on various configurations and operating principles within the scope and spirit of the present subject matter and is generally configured for vapor deposition of a source material, such as CdTe, as a thin film on the PV module substrates 14. In the embodiment of the system 10 shown in FIG. 1, the apparatus 60 is a module that includes a casing in which the internal components are contained, including a vacuum deposition head mounted above a conveyor assembly. The conveyor assembly in the apparatus 60 may be in accordance with aspects of the present invention, or may be any other type of conveyor that is particularly designed for the vapor deposition process within the apparatus 60.

The vacuum chamber 12 also includes a plurality of interconnected cool-down modules 20 within the vacuum chamber 12 downstream of the vapor deposition apparatus 60. The cool-down modules 20 define a cool-down section within the vacuum chamber 12 in which the substrates 14 having the thin film of source material deposited thereon are allowed to cool at a controlled cool-down rate prior to the substrates 14 being removed from the system 10. Each of the modules 20 may include a forced cooling system wherein a cooling medium, such as chilled water, refrigerant, or other medium is pumped through cooling coils configured with the modules 20.

Additionally, in the illustrated embodiment of the system 10, at least one post-heat module 22 is located immediately downstream of the vapor deposition apparatus 60 and before the cool-down modules 20. As the leading section of a substrate 14 is conveyed out of the vapor deposition apparatus 60, it moves into the post-heat module 22, which maintains the temperature of the substrate 14 at essentially the same temperature as the remaining portion of the substrate 14 within the vapor deposition apparatus 60. In this way, the leading section of the substrate 14 is not allowed to cool while the trailing section of the substrate 14 is still within the vapor deposition apparatus 60. If the leading section of a substrate 14 were allowed to cool as it exited the apparatus 60, a non-uniform temperature would be generated longitudinally along the substrate 14. This condition could result in the substrate breaking from thermal stress.

As diagrammatically illustrated in FIG. 1, a feed device 24 is configured with the vapor deposition apparatus 60 to supply source material, such as granular CdTe. Preferably, the feed device 24 is configured so as to supply the source material without interrupting the continuous vapor deposition process within the apparatus 60 or conveyance of the substrates 14 through the apparatus 60.

Still referring to FIG. 1, the individual substrates 14 are initially placed onto a load conveyor module 26, and are subsequently moved into an entry vacuum lock station that includes a load module 28 and a buffer module 30. A “rough” (i.e., initial) vacuum pump 32 is configured with the load module 28 to draw an initial vacuum, and a “fine” (i.e., high) vacuum pump 38 is configured with the buffer module 30 to increase the vacuum in the buffer module 30 to essentially the vacuum within the vacuum chamber 12. Valves 34 (e.g., gate type slit valves or rotary-type flapper valves) are operably disposed between the load conveyor 26 and the load module 28, between the load module 28 and the buffer module 30, and between the buffer module 30 and the vacuum chamber 12. These valves 34 are sequentially actuated by a motor or other type of actuating mechanism 36 in order to introduce the substrates 14 (starting at atmospheric pressure) into the vacuum chamber 12 in a step-wise manner without affecting the vacuum within the chamber 12.

An exit vacuum lock station is configured downstream of the last cool-down module 20, and operates essentially in reverse of the entry vacuum lock station described above. For example, the exit vacuum lock station may include an exit buffer module 42 and a downstream exit lock module 44. Sequentially operated valves 34 are disposed between the buffer module 42 and the last one of the cool-down modules 20, between the buffer module 42 and the exit lock module 44, and between the exit lock module 44 and an exit conveyor module 46. A fine vacuum pump 38 is configured with the exit buffer module 42, and a rough vacuum pump 32 is configured with the exit lock module 44. The pumps 32, 38 and valves 34 are sequentially operated to move the substrates 14 out of the vacuum chamber 12 in a step-wise fashion without loss of vacuum condition within the vacuum chamber 12.

Additionally, the system 10 also includes a coordinated conveyor system configured to move the substrates 14 into, through, and out of the vacuum chamber 12. In the illustrated embodiment, this conveyor system includes a plurality of individually controlled conveyor assemblies 100, with each of the various modules in the system 10 including one or more of the conveyor assemblies 100. All or any combination of these conveyor assemblies 100 may be configured in accordance with aspects of the present subject matter, as will be described in greater detail below. The respective conveyor assemblies 100 include conveyor drive units 102 that control the conveyance rate of substrates 14 through the respective modules.

As described above, each of the various modules and respective conveyors in the system 10 are independently controlled to perform a particular function. For such control, each of the individual modules may have an associated independent controller 50 configured therewith to control the individual functions of the respective module, including the conveyance rate of the conveyor assemblies 100. The plurality of controllers 50 may, in turn, be in communication with a central system controller 52, as illustrated in FIG. 1. The central system controller 52 can monitor and control (via the independent controllers 50) the functions of any one of the modules so as to achieve an overall desired heat-up rate, deposition rate, cool-down rate, and so forth, in processing of the substrates 14 through the system 10.

Referring still to FIG. 1, for independent control of the functions performed by the modules within the overall system configuration 10, including individual control of the respective conveyor assemblies 100, the modules include active-sensing viewport assemblies 54 that detect the presence of the substrates 14 as they are conveyed through the module. The viewport assemblies 54 are in communication with the respective module controller 50, which is in turn in communication with the central controller 52. Alternatively, the viewport assemblies 54 may be in direct communication with the central controller 52. In this manner, the individual respective conveyor assemblies 100 may be controlled to ensure that a proper spacing between the substrates 14 is maintained and that the substrates 14 are conveyed at the desired constant conveyance rate through the vacuum chamber 12. It should be appreciated that the viewport assemblies may be used for any other control function related to the individual modules or overall system 10.

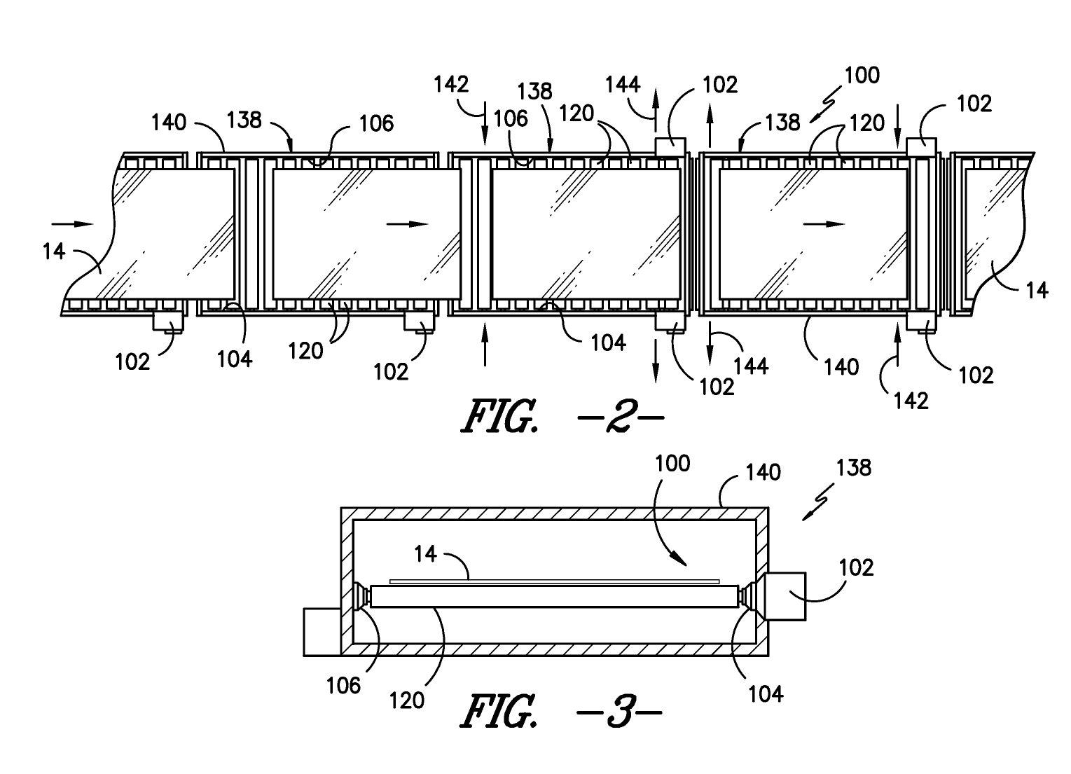

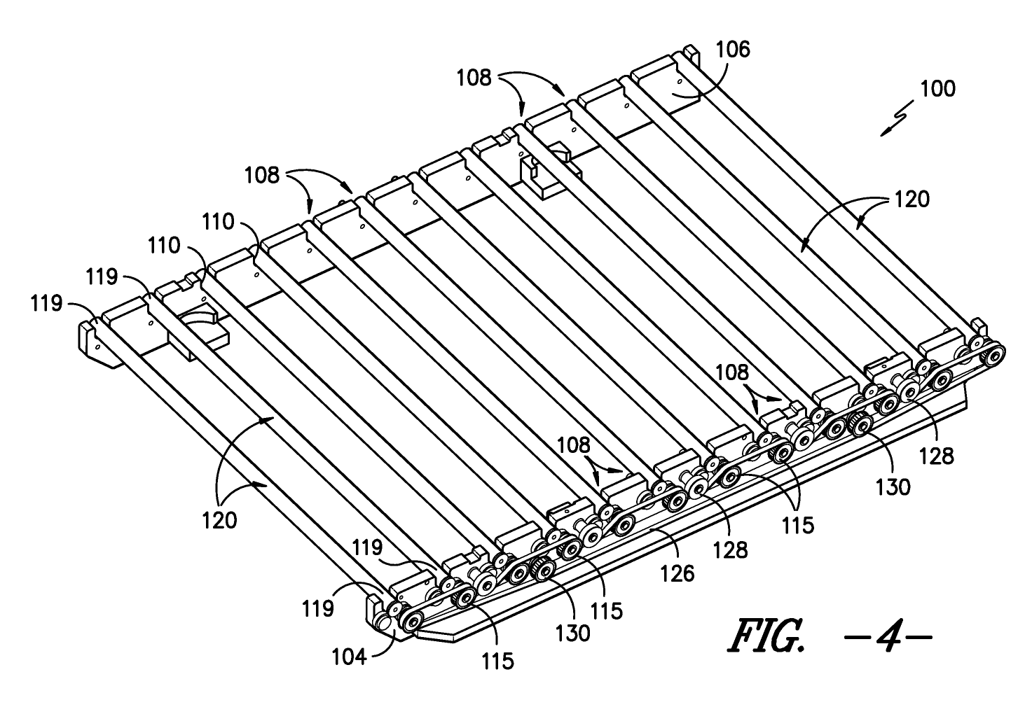

Referring now to FIGS. 2 and 3, one embodiment of a conveyor assembly 100 configured with individual modules 138 is illustrated in accordance with aspects of the present subject matter. These modules 138 may be, for example, any one or combination of the modules 26, 28, 16, 30, 22, 20, 42, 44, and 46 discussed above with respect to FIG. 1. It should thus be appreciated that the conveyor assembly 100 is not limited to any particular type of module or other functioning device.

The respective conveyor assemblies 100 include at least one drive unit 102 configured with the modules 138. In the embodiment illustrated in FIG. 2, a drive unit 102 is illustrated on each respective longitudinal side of the first two modules 138 (right-hand modules) to illustrate that each longitudinal side is a drive side wherein rollers 120 of the conveyor assemblies 100 are rotationally driven at the roller positions along each longitudinal side of the assembly 100. The two left-hand assemblies 138 in FIG. 2 are illustrated with a single drive unit 102 on one longitudinal side of the modules 138. This represents that the rollers 120 for such conveyor assemblies 100 are driven along one longitudinal side. The opposite ends of the rollers 120 are carried in idler wheels, as discussed in greater detail below.

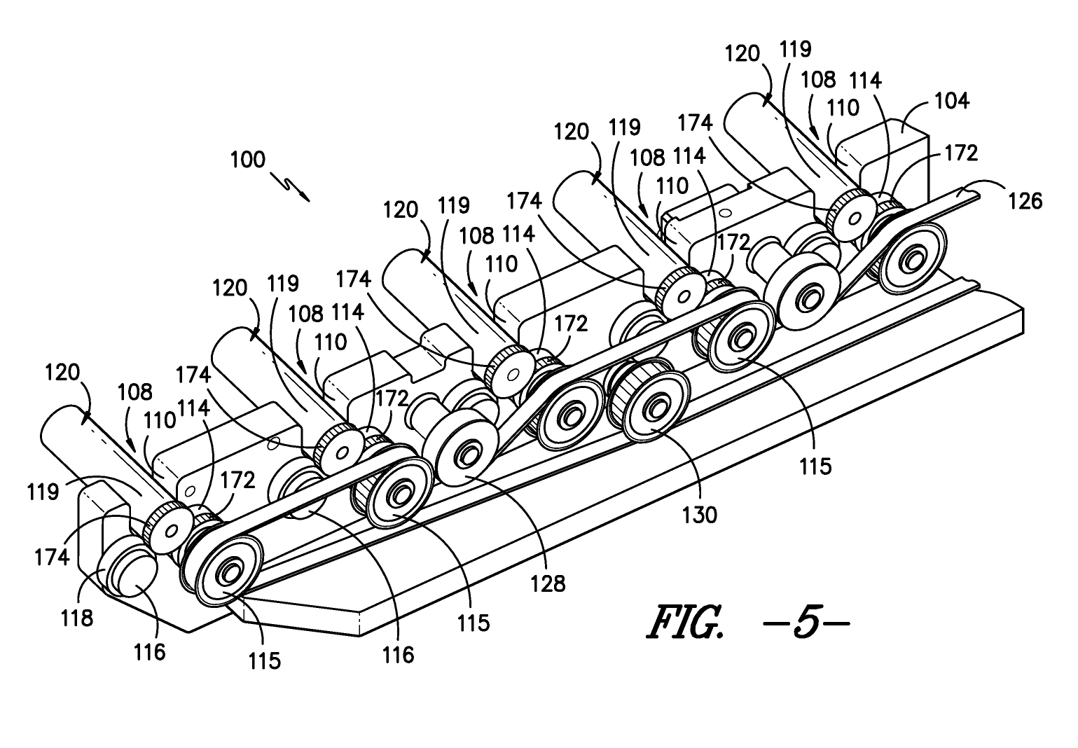

The conveyor assemblies 100 are not limited to any particular type or configuration of drive unit 102. In this regard, the drive unit 102 is generically depicted in the figures. In a particular embodiment described herein, the drive unit 102 may be a motor that serves to drive a drive belt 126 (FIGS. 4 and 5) in an endless loop, as described in greater detail below.

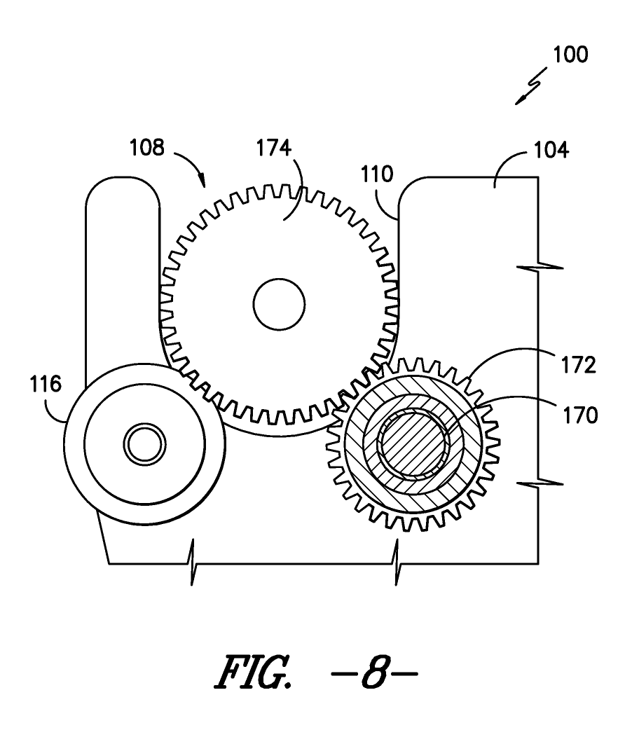

Referring to FIGS. 2-8 in general, the conveyor assemblies 100 generally include a first carriage rail 104 at a drive side of each conveyor assembly 100 and a second carriage rail 106 disposed at an opposite side of each conveyor assembly 100. The first and second carriage rails 104, 106 include a plurality of distinct roller positions 108 spaced longitudinally along the length of the respective rails. As particularly shown in FIG. 7, these roller positions 108 may be defined by, for example, open-ended recesses 110 that may have a generally U-shaped profile. In such an embodiment, the recesses 110 may have dimensions (slightly larger than the roller diameter) for receipt of the ends 119 of a plurality of rollers 120, as depicted in FIGS. 4 and 5.

The first and second carriage rails 104, 106 may be formed of any suitable material configured for the particular type of environment in which the conveyor assembly 100 is intended. In an embodiment wherein the conveyor assemblies 100 are used in a relatively high temperature vacuum deposition system 10, as described above with respect to FIG. 1, it may be desired to internally cool the carriage rails 104, 106 with a forced circulation cooling medium. FIG. 2 depicts a coolant inlet 142 and a coolant outlet 144 for this purpose. The carriage rails 104, 106 may include any manner of internal cooling channels through which a cooling medium, such as chilled water, refrigerant, gas, or the like, circulates in order to maintain the components at an effective temperature for sustained operation in their intended environment.

Referring particularly to FIGS. 5-8, the first and second carriage rails 104, 106 may include a pair of wheels at each of the roller locations 108. In several embodiments, if the carriage rail is on a drive side of the conveyor assembly, then a plurality of the roller positions 108 may be configured as drive positions, wherein each pair of wheels at each drive position includes a drive wheel 114 and an idler wheel 116. Desirably, each roller 120 includes at least one drive wheel, which may be at the roller location 108 at either the first carriage rail 104 or the second carriage rail 106. It should also be appreciated that not every roller position 108 need be configured as a drive position. For example, idler positions may be interspaced between drive positions along either or both of the carriage rails 104, 106. In other words, even for drive sides of the conveyor assembly, not every roller 120 needs to be driven. In the illustrated embodiments, each of the roller positions 108 along the first carriage rail 104 are configured as drive positions.

The wheels 114, 116 may be disposed relative to the bottom of the respective recesses 110 so as to define a cradle for the rollers 120, which may allow for the rollers 120 to be supported on the wheels 114, 116 without contacting the first and second carriage rails 104, 106. For example, as particularly shown in FIG. 7, the roller 120 may be configured to rest on the wheels 114, 116 such that roller 120 does not contact the walls of the recess 110. Thus, the wheels 114, 116 may generally serve to rotationally support the rollers 120 within the recesses 110. For this purpose, the wheels 114, 116 may include a grip-enhancing surface 118, such as a rubber-like coating, series of o-rings, flat rubber ring and the like. The surface 118 serves to reduce rotational slippage between the rollers 120 and the respective wheels 114, 116.

As particularly shown in FIGS. 4 and 5, the rollers 120 may generally be configured to extend between the first and second carriage rails 104 106 such that the ends 119 of the rollers 120 may be essentially dropped into the cradles defined by the wheels 114, 116 at the respective roller positions 108. As such, the rollers 120 may be easily and readily removable from the rails 104, 106 for repair, replacement, or any other reason simply by lifting the rollers 120 vertically out of the roller positions 108. It should also be appreciated that the rollers 120 may be formed of any suitable material, such as ceramic, aluminum, steel, and the like.

Referring to FIGS. 4-6 in particular, the drive wheel 114 at each of the roller positions 108 may be formed integrally with or otherwise secured to a drive pulley 115. The drive pulleys 115 may generally comprise wheels engaged by a tensioned drive belt 126. The drive belt 126 runs in an endless loop path along the length of the first carriage rail 104 and engages each of the drive pulleys 115, as particularly illustrated in FIGS. 4 and 5. In order to maintain a proper tension on the drive belt 126, one or more adjustable tension rollers 128 may be provided along the length of the carriage rail 104. Likewise, any number of return wheels 130 may be provided to ensure proper guidance and deflection of the drive belt 126 along its return path. The drive pulleys 115 and return wheels 130 may also include any configuration of traction-enhanced surface for engagement with the drive belt 126. For example, the pulleys 115 and return wheels 130 may include a knurled surface or any other type of surface that is compatible with the surface of the drive belt 126 to ensure sufficient fraction between the drive belt 126 and the respective wheels. In the illustrated embodiment wherein a cogged belt and cogged wheels are used, generally no slippage occurs between the components.

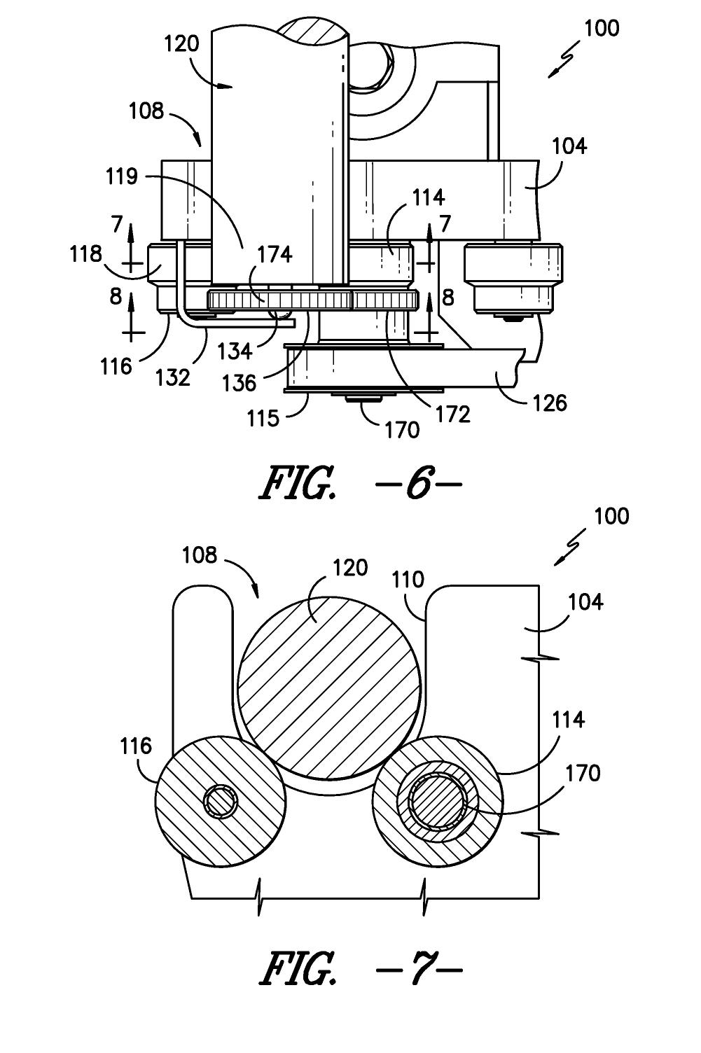

In addition, as particularly shown in FIGS. 5-6 and 8, each drive pulley 115 may be configured to rotatably drive a drive gear 172 positioned between the drive pulley 115 and the drive wheel 114. In one embodiment, the drive pulley 115, drive gear 172 and drive wheel 114 may be supported by a shaft 170 (FIGS. 6-8) mounted to the carriage rail 104, 106. The drive gear 172 may generally be configured to rotatably engage a corresponding roller gear 174 coupled to the end 119 of each roller 120 disposed at a drive position of the conveyor assembly 100. Specifically, as shown in FIG. 8, the drive gear 172 may mesh with the roller gear 174 coupled to the end 119 of the roller 120. Thus, as the drive pulley 115 is rotated, the drive and roller gears 172, 174 may, in turn, be rotated, thereby resulting in rotation of the corresponding roller 120.

It should be appreciated that the dimensions of the drive and roller gears 172, 174 and/or the dimensions of the wheels 114, 116 may be selected such that, when each drive gear 172 is rotationally engaged with its corresponding roller gear 174, the rollers 120 may be configured to remain in contact with and be rotationally supported by the wheels 114, 116 disposed at each roller position. For example, as shown in FIGS. 7 and 8, the dimensions may be selected such that the gears 172, 174 mesh at their pitch diameters when each roller 120 is supported within the cradle defined by the wheels 114, 116.

It should also be appreciated that, as an alternative to the geared configuration, the rollers 120 may be mechanically driven using any other suitable mechanical drive device known in the art.

As indicated above, it should be appreciated that the drive units 102 may be configured to drive the belt 126 in its endless-loop path using any suitable mechanical configuration. For example, the drive unit 102 may include a motor that is rotationally engaged with one or more of the drive pulleys 115 through any suitable gearing arrangement. In an alternate embodiment, a separate drive pulley may be provided anywhere along the path of the belt 126 to drive the belt in its endless-loop path. It should be readily appreciated that various suitable drive arrangements are within the scope and spirit of the present subject matter for this purpose.

Additionally, as mentioned above with respect to the discussion of FIGS. 4 and 5, it is not necessary that the second carriage rail 106 include drive wheels 114 at the respective roller positions 108. The roller positions 108 along the second carriage rail 106 may simply include a pair of non-driven idler wheels 116 at each of the rollers positions 108 to define the cradle for the ends 119 of the rollers 120. Alternatively, it may be desired to include a respective drive unit 102 configured with the second carriage rail 106 in the same type of configuration described above with respect to the first carriage rail 104.

As particularly shown in FIG. 6, a contact member 132 may be disposed at each of the roller positions 108 that defines a contact bearing surface for the end faces 136 of the roller gears 174 (or the end faces 136 of the rollers 120 positioned at non-drive positions). In the embodiment shown in FIG. 6, a point of contact is defined by a protrusion 134, such as a nub or other member, defined concentrically on the axial end face 136 of the roller gear 174. This protrusion 134 bears against the contact member 132 to prevent axial creeping of the rollers 120 relative to the first carriage rail 104. The same or similar configuration may be provided at the roller positions 108 along the second carriage roll 106 for the same purpose.

Although not depicted herein, it should be appreciated that any manner of structure may be disposed along the top surface of the respective rails 104, 106 to prevent inadvertent ejection of the rollers 120 from the respective roller positions 108. The structure may be, for example, shielding, a lock bar, or any other type of readily removable structure. If such structure is provided, then the structure would need to be removed from the rails 104, 106 for subsequent removal of the rollers 120.

As mentioned above, the present subject matter also encompasses any manner of vapor deposition modules for use in conveying a substrate 14 through a vapor deposition system, such as the system 10 shown in FIG. 1, wherein a source material is converted to a vapor and deposited onto a surface of the substrates 14. Referring to FIGS. 2 and 3 for example, any manner of such modules 138 may include a housing structure 140 in which the conveyor assembly 100 is operationally configured. The housing structure 140 may include side walls, with the carriage rails 104, 106 mounted between the side walls. The conveyor assembly 100 configured within the housing structure 140 may be in accordance with any of the embodiments described above.

Similarly, the present subject matter also encompasses a vapor deposition system, such as the system 10 described above with respect to FIG. 1, for converting to vapor and depositing a source material onto a surface of substrates 14 conveyed through the system 10. The system 10 may include a plurality of individual, longitudinally aligned modules that define a conveyance path for the substrates 14 conveyed through the system 10. The modules may be any one or combination of the different types of modules described above with respect to FIG. 1. The modules and respective conveyor assemblies 100 may be in accordance with any one of the embodiments described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A conveyor assembly for conveying substrates through a vapor deposition system, the conveyor assembly comprising:
a first carriage rail disposed on a drive side of the conveyor assembly and a second carriage rail disposed on an opposite side of the conveyor assembly, the first and second carriage rails defining a plurality of roller positions spaced apart longitudinally therealong, a plurality of the roller positions on the first carriage rail being configured as drive positions,
a drive pulley disposed at each drive position, each drive pulley configured to rotationally drive a drive device; and
a plurality of rollers extending between the first and second carriage rails at the roller positions, the rollers disposed at the drive positions configured to engage the drive devices.

2. The conveyor assembly of claim 1, wherein the drive device comprises a drive gear disposed at each drive position and wherein the rollers disposed at the drive positions including roller gears configured to engage the drive gears, the drive pulleys being configured to rotate the drive and roller gears such that substrates positioned on the rollers are conveyed longitudinally along the conveyor assembly.

3. The conveyor assembly of claim 2, wherein the roller gears are configured to be mounted to the ends of the rollers disposed at the drive positions.

4. The conveyor assembly of claim 1, further comprising a pair of wheels disposed at each of the roller positions, the wheels being spaced apart from one another so as to define a cradle at each respective roller position, the rollers being supported within the cradles at the roller positions.

5. The conveyor assembly of claim 4, wherein at least one of the wheels at each drive position is configured as a drive wheel, each drive wheel being configured to be rotationally driven by one of the drive pulleys.

6. The conveyor assembly of claim 4, wherein the rollers are configured to be dropped into the cradles at the roller positions such that the rollers are removable form the first and second carriage rails by being lifted out of the cradles at the roller positions.

7. The conveyor assembly of claim 4, wherein the roller positions are formed by open-ended recesses defined in the first and second carriage rails, the rollers being supported within the cradles such that the rollers do not contact the first and second carriage rails.

8. The conveyor assembly of claim 1, wherein the drive pulleys are rotationally driven by a common drive belt.

9. The conveyor assembly of claim 8, further comprising at least one adjustable tension roller configured on the first carriage rail around which the common drive belt at least partially runs.

10. The conveyor assembly of claim 8, further comprising a drive unit configured to drive the common drive belt.

11. A vapor deposition module for use in conveying a substrate through a vapor deposition system wherein a source material is converted to a vapor and deposited onto a surface of the substrate, the vapor deposition module comprising:
a housing;
a conveyor assembly operably configured within the housing to convey a substrate through the housing, the conveyor assembly comprising:
a first carriage rail disposed on a drive side of the conveyor assembly and a second carriage rail disposed on an opposite side of the conveyor assembly, the first and second carriage rails defining a plurality of roller positions spaced apart longitudinally therealong, a plurality of the roller positions on the first carriage rail being configured as drive positions,
a drive pulley disposed at each drive position, each drive pulley configured to rotationally drive a drive device; and
a plurality of rollers extending between the first and second carriage rails at the roller positions, the rollers disposed at the drive positions configured to engage the drive devices.

12. The vapor deposition module of claim 11, wherein the drive device comprises a drive gear disposed at each drive position and wherein the rollers disposed at the drive positions including roller gears configured to engage the drive gears, the drive pulleys being configured to rotate the drive and roller gears such that substrates positioned on the rollers are conveyed longitudinally along the conveyor assembly.

13. The vapor deposition module of claim 12, wherein the roller gears are configured to be mounted to the ends of the rollers disposed at the drive positions.

14. The vapor deposition module of claim 11, further comprising a pair of wheels disposed at each of the roller positions, the wheels being spaced apart from one another so as to define a cradle at each respective roller position, the rollers being supported within the cradles at the roller positions.

15. The vapor deposition module of claim 14, wherein at least one of the wheels at each drive position is configured as a drive wheel, each drive wheel being configured to be rotationally driven by one of the drive pulleys.

16. The vapor deposition module of claim 14, wherein the rollers are configured to be dropped into the cradles at the roller positions such that the rollers are removable form the first and second carriage rails by being lifted out of the cradles at the roller positions.

17. The vapor deposition module of claim 14, wherein the roller positions are formed by open-ended recesses defined in the first and second carriage rails, the rollers being supported within the cradles such that the rollers do not contact the first and second carriage rails.

18. The vapor deposition module of claim 11, wherein the drive pulleys are rotationally driven by a common drive belt.

19. The vapor deposition module of claim 18, further comprising at least one adjustable tension roller configured on the first carriage rail around which the common drive belt at least partially runs.

20. A vapor deposition system configured for converting to vapor and depositing a source material onto a surface of a substrate conveyed through the system, the vapor deposition system comprising:
a plurality of individual, longitudinally aligned modules, the modules defining a conveyance path for substrates conveyed through the system, each of the modules comprising:
a housing;
a conveyor assembly operably configured within the housing to convey the substrate through the housing, said conveyor assembly comprising:
a first carriage rail disposed on a drive side of the conveyor assembly and a second carriage rail disposed on an opposite side of the conveyor assembly, the first and second carriage rails defining a plurality of roller positions, a plurality of the roller positions on the first carriage rail being configured as drive positions,
a drive pulley disposed at each drive position, each drive pulley configured to rotatably drive a driven device; and
a plurality of rollers extending between the first and second carriage rails at the roller positions, the rollers disposed at the drive positions configured to engage the drive devices.
